(19) United States
(12) Patent Application Publication
(10) Pub. No.: US 2024/0073569 A1
(43) Pub. Date: Feb. 29, 2024

(54) Telescopic High SPL Speaker Enclosure

(71) Applicant: STEPHAN HOCH, CHIAVARI (IT)

(72) Inventor: STEPHAN HOCH, CHIAVARI (IT)

(21) Appl. No.: 17/823,085

(22) Filed: Aug. 30, 2022

(51) Int. Cl. H04R 1/02

(52) U.S. Cl. CPC H04R 1/023; H04R 1/026

(57) ABSTRACT

Loudspeaker enclosure (4) with at least two enclosure sections (1, 2) which can be moved relative to one another into a transport state (3) and into an operating state (5). In the operating state (5), the enclosure sections (1, 2) are connected to one another via a locking device. The enclosure sections (1, 2) each have one or more sealing elements (35, 37) which are pressed against one another by the locking device with a force F during the operating state (5).

### FIELD OF THE INVENTION

The present invention is encompassed within the field of the loudspeakers for the connection thereof with any audio device. More specifically and due to their special characteristics, the present invention relates to a telescopic loudspeaker capable of achieving high Sound Pressure Level (SPL).

### PRIOR ART

Telescopic Speakers where the speaker cabinet is divided into at least two sections where one of the two sections can be pushed into the other section during transport mode are known; the two sections are kept together during operation mode by simple gaskets, springs or other mechanisms which do not provide the force necessary to keep the two sections pressed against each other in order to avoid vibrations (that will lead to distortion) and leakages when it comes to high sound pressure levels. The known systems are suited for Portable PCs, small HiFi devices, etc. while the present invention is also suited for all systems where high SPL is needed such as (but not limited to) Bass Amplifiers and Public Address (live concerts etc).

### DESCRIPTION OF RELATED ART

Loudspeakers are used in different sizes by artists and/or concert organizers. The artists perform on different stages and/or in different locations. The loudspeakers are set up and taken on the stages. After the end of a concert, the loudspeaker enclosures with the speakers arranged in them are often transported to the next venue. Large-volume loudspeaker enclosures are often required for adequate sound reinforcement since the volume enclosed by the loudspeaker cabinet is crucial for high-quality reproduction of low frequencies. However, the size of the respective loudspeakers proves to be disadvantageous with regard to the storage and transport of the loudspeakers.

In the case of known loudspeaker enclosures, attempts have already been made to temporarily reduce the volume of the loudspeaker enclosure, for example for transport purposes. In order to reduce the volume, enclosure sections have been shifted relative to one another, for example.

At the same time, the respective enclosure sections must be able to be connected to one another in a soundproof and vibration-proof manner for the operating state since mutually leaking enclosure sections often result in sound turbulence, resulting in audible distortion and negatively affecting sound quality.

The object of the invention is therefore to provide a loudspeaker enclosure which avoids the shortcomings of known telescopic loudspeaker enclosures even at high sound pressure levels.

### BRIEF DESCRIPTION OF DRAWINGS

FIG. 1 shows the enclosure sections of the loudspeaker enclosure in the transport state in a plan view.

FIG. 2 shows a loudspeaker in an operating state in a plan view and includes a detail-view on the sealing elements,

FIG. 3 shows a side view of a loudspeaker enclosure according to embodiment 1, with a first enclosure section and a further enclosure section in a transport state,

FIG. 4 shows side view of a loudspeaker enclosure according to embodiment 1, with a first enclosure section and a further enclosure section in a operating state

FIG. 5 shows a representation corresponding to FIG. 4, with the difference that two rods are shown in the operating state, each of which has a self-locking joint

FIG. 6 is a detail of FIG. 5 and shows the rod of a loudspeaker enclosure with sections aligned axially with respect to one another,

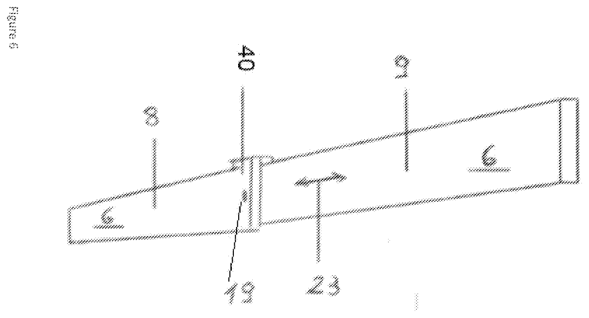

FIG. 7 shows a plan view of a loudspeaker enclosure according to embodiment 2, with a first enclosure section and a further enclosure section in a operating state

FIG. 8 shows a plan view of he enclosure sections of the loudspeaker enclosure in the transport state according to embodiment 3 with lever locks and hinges,

FIG. 9 shows the loudspeaker enclosure according to embodiment 3 with two enclosure sections in the operating state, with hinges, hinge parts and lever locks.

FIG. 10 shows the details of hinges, hinge parts and lever locks related to FIG. 9

FIG. 11 shows an example of full automation using a linear actuator in transport mode

FIG. 12 shows an example of full automation using a linear actuator in operation mode

FIG. 13 shows an example of partial automation using a rotary actuator

### REFERENCE NUMBERS

1 first enclosure section
2 further enclosure section
3 transport condition
4 loudspeaker enclosure
operating condition
6 rod
7a,b Blocking bar
8 section (rod 6)
9 section (rod 6)
10 rod
11 section (rod 10)
12 section (rod 10)
13 pivot point
14 pivot point
15 pivot point
16 pivot point
17 Pivoting axis (rod 6)
18 Pivoting axis (rod 10)
19 Joint
20 Joint
21 Blocking and/or fixing component
22 Blocking and/or fixing component
23 Axial arrangement
24 Axial arrangement
25 Fixing wheel
26 Fixing wheel
27 V-shape
28 Overstretched shape
29 arcuate shape
(30 Not used)
(31 Not used)
32 end face
(33 Not used)
34a,b hinge
35 sealing element
35a solid frame of sealing element
35b soft stripe of sealing element
36 access opening of external enclosure section (2)
37 sealing element
38 Rear
39 Force F
40 Component
41 Component
42 Speaker
43 Lever lock
44 Lever lock
45 Hinge
45a Hinge part
45b Hinge part
46 Hinge
46a Hinge part
46b Hinge part
47 Profile protection
48 Profile protection
(49 Not used)
(50 Not used)
(51 Not used)
(52 Not used)
(53 Not used)
(54 Not used)
55a lever lock part
55b lever lock part
56a lever lock part
56b lever lock part
57 automation device (linear actuator)
58 automation device (rotary actuator)
59 bar
60 bar

### DESCRIPTION OF THE INVENTION

It is therefore an object of the invention to provide a telescopic loudspeaker enclosure which avoids leaks and vibrations between the sections during operation mode even at high Sound Pressure Levels.

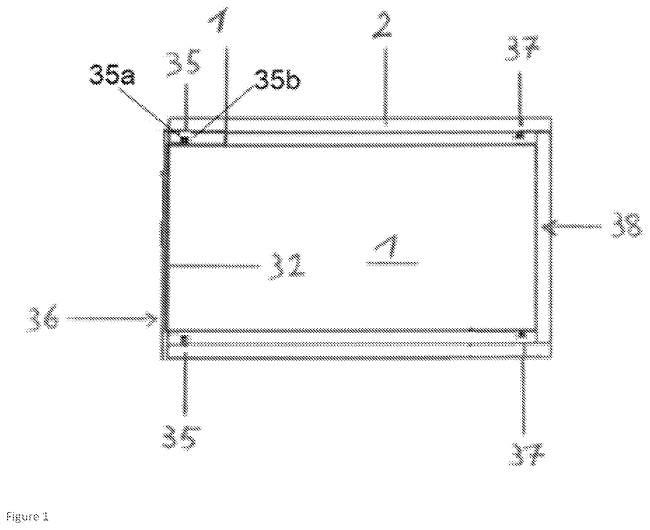

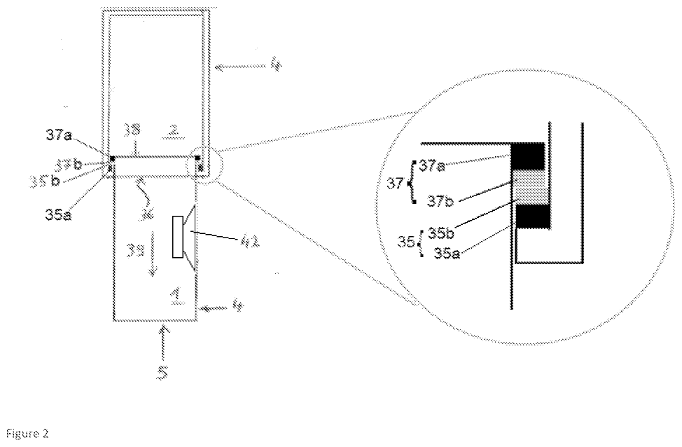

The above-identified object is achieved by a loudspeaker enclosure (see Part 4 on FIG. 2) that has at least two enclosure sections (see Part 1 and Part 2 on FIG. 1 and FIG. 2). The enclosure can be converted into a transport state (FIG. 1) and into an operating state (FIG. 2) by pivoting the sections relative to one another in a telescopic way.

The inner section is surrounded by a sealing element (FIG. 1 and FIG. 2, part 37) and the outer section has a sealing element on the inside (FIG. 1 and FIG. 2, part 35). After reaching the maximum opening (FIG. 2) the inner enclosure sections is stopped by the sealing elements 35, 37.

The sealing elements are realized as a solid frame (FIG. 2 part 35a—in black) with a stripe of soft material (for example neoprene)—see part 35b (in gray).

In the operating state, the enclosure sections are connected to one another via a locking device. During the operating state the locking device presses the sealing elements against each other with a force F that is sufficient to avoid the mentioned vibrations, leakages and distortions. During the transport state the locking device is released and the enclosure sections can be pivoted relative to one another in a telescopic way.

The loudspeaker forms a unit consisting of one or more speaker (i.e. electrical-acoustical transducer that transforms an electric signal in an acoustic signal) and an enclosure (composed of at least two enclosure sections) where the loudspeaker is assembled. In addition to the speaker(s), the loudspeaker preferably includes cabling and possibly a crossover network. Insulating material can also be arranged in the loudspeaker enclosure.

Preferably, but by no means exclusively, an amplifier may be located within the speaker cabinet. Such an amplified loudspeaker is also referred to as an active loudspeaker.

The invention is applicable to loudspeakers having speaker cabinets of the so-called closed type. Of course, the invention can also be used for so-called bass reflex cabinets, horn speakers and other types of speaker cabinets.

At least one loudspeaker can be attached to at least one wall (any wall) of an enclosure section.

Electromechanical or hydraulic devices can be provided with which—eventually reversible—the first enclosure section and the further enclosure section can be transferred from the transport state to the operating state against one another. Of course other technical devices can also be used to transfer the first enclosure section from the transport state to the operating state.

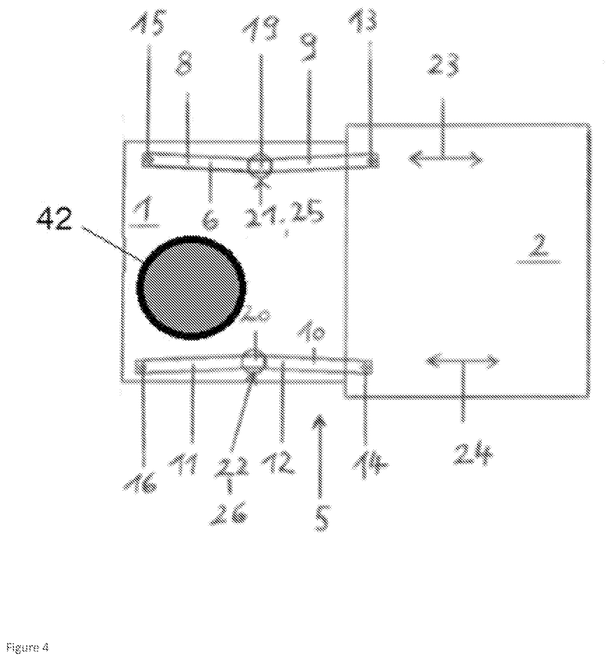

Futher feature is that the speaker may be protected from environmental influences during transport by placing the loadspeaker on a wall of the inner enclosure section (see FIG. 4, part 42). Fluids and/or solids cannot penetrate into the interior of the loudspeaker enclosure. Protective covers and/or other protective devices for the loudspeaker enclosure during storage or transport are no longer required.

### DETAILED DESCRIPTION OF THE INVENTION

### First Embodiment

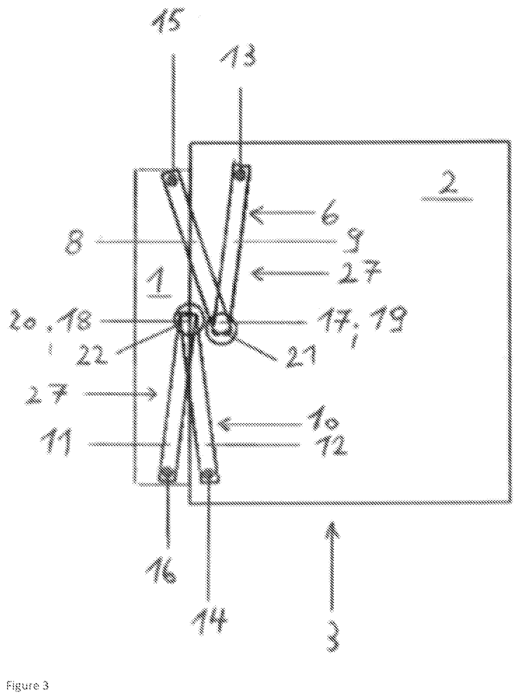

In a first embodiment (FIGS. 3, 4 and 5), the invention provides at least one rod (Part 6, 10) for moving the two enclosure sections relative to one another. The rod comprises at least two sections (Parts 8, 9, 11, 12) that can be moved relative to one another.

Each rod has two sections. Each section is arranged with its fixed end in the joint (Part 19, 20). One of the two sections of the rod is articulated with its free end on the first enclosure section. The other section of the rod is articulated with its free end on the further enclosure section.

The respective sections of the rod are preferably connected in a rotatable way to one another via a joint. A swivel hinge can also be used instead of a joint.

In FIGS. 3,4 and 5, it is assumed, for example, that the two sections of the rod are connected to one another via a joint (19, 20).

The two mutually movable sections of a rod can be pivoted between an angle of 0° and an angle of approximately 180° via the joint.

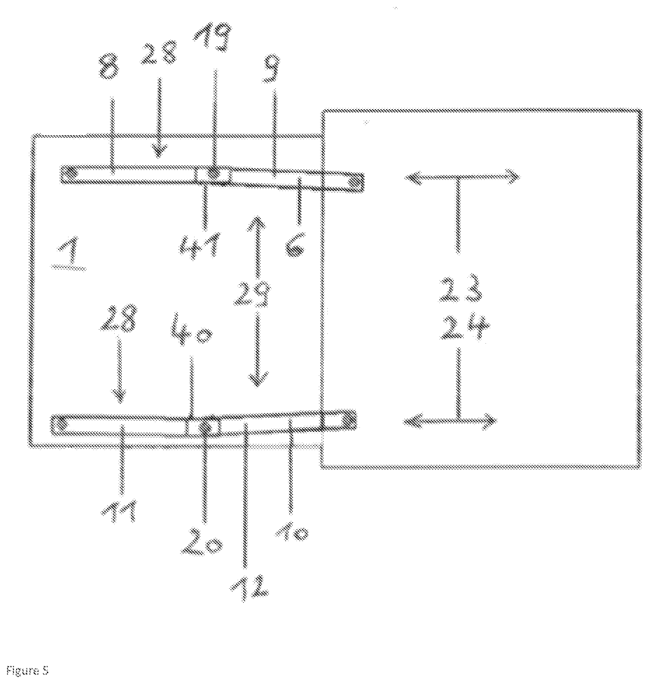

In the transport state, the sections of the rod are arranged around the joint at an angle close to 0° to one another (FIG. 3, shape 27). In the operating state (FIG. 4, 5), the mutually movable sections of a rod are preferably arranged at an angle of approximately 180° to one another (FIG. 5, shape 28) thus pushing the sections in opposite direction with force F.

Preferably, but not exclusively, the joint can be made immobilized in a form-fitting manner, in particular by means of a fixing wheel (FIG. 1,2; Part 25, 26). The mobility of the joint is restricted by the fixing wheel in such a way that the two sections of a rod can no longer be pivoted in relation to one another. It goes without saying that the fixing wheel can be released again to establish the mobility of the sections of the rod relative to one another.

(FIG. 5, 6) The joint can include components (Part 40, 41) with which the joint blocks itself when the mutually movable sections of the rod are at least temporarily overstretched by an angle of 180°. To solve the self-blockage, the sections of the rod are pivoted again, at least temporarily, through an angle of 180°. After resolving the self-blockage, the rod sections can be returned to the transport state.

The rod can be moved and the joint can be fixed by an electrical, pneumatic or other automatism. In this case the rod and joint may be placed inside the enclosure.

### Second Embodiment

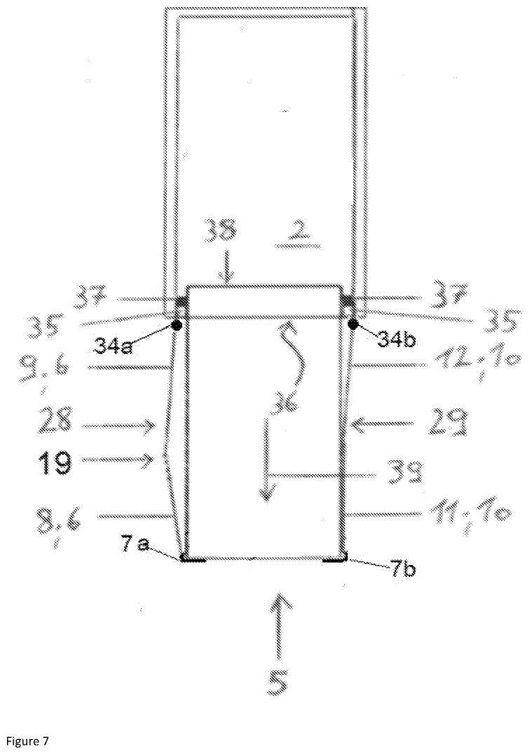

FIG. 7 shows another placement of the rods (Parts 6, 10) and rod sections (8, 9, 11, 12). The two sections of the rod are connected to one another via a joint (19).

One rod section is connected with a hinge (34a, b) to one enclosure section and the other is free.

The user positions the free rod section against the other enclosure section (against blocking bar 7a,b) and pushes the rod from position 28 towards the wall (see 29). This pushes the enclosure section 1 in direction 39 with force F.

In FIG. 7 the rod sections 9, 12 are connected to enclosure section 2 and the rod sections 8, 11 are pushed against enclosure section 1 but any configuration or rod lengths (could be much shorter) resulting in a force F(39) can be used.

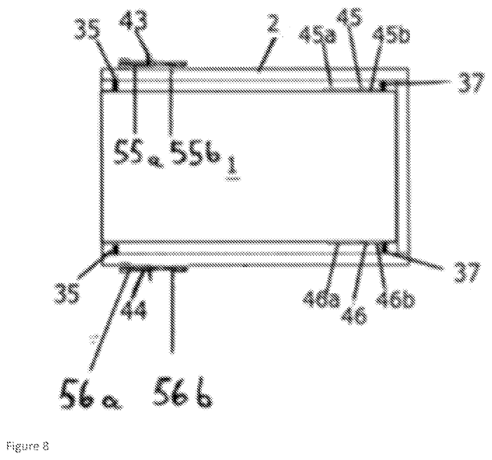

### Third Embodiment (FIG. 8,9,10)

The third embodiment provides a loudspeaker enclosure that includes a locking device whose parts that can be pivoted relative to one another are each designed as a hinge (parts 45, 46) and a lever lock (parts 43, 44). Each hinge interacts with a lever lock.

A hinge is arranged on the first enclosure section (smaller cross section). In the transport state of the enclosure sections, the first enclosure section is at least partially introduced into the further enclosure section with the higher cross section.

A lever lock is arranged on the further enclosure section which has the higher cross section.

In the transport state (FIG. 8), the respective hinge is detached from the respective lever lock. The hinge is located inside the further enclosure section. The lever lock interacts with a lock. The lock may be positioned on the outside of an end face of the first enclosure section. In the transport state, the lever lock interacts with the lock and thus secures the first enclosure section relative to the further enclosure section against undesired movement of the first enclosure section.

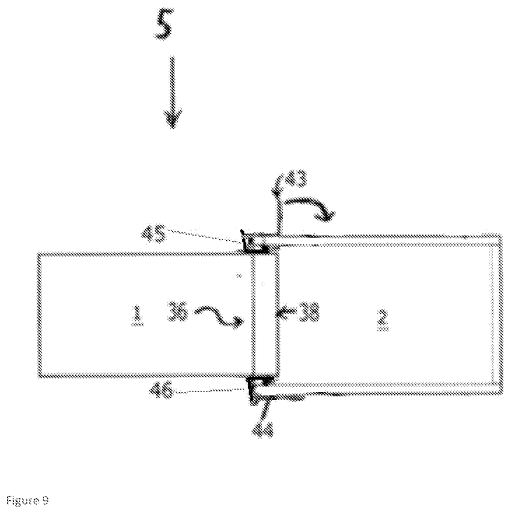

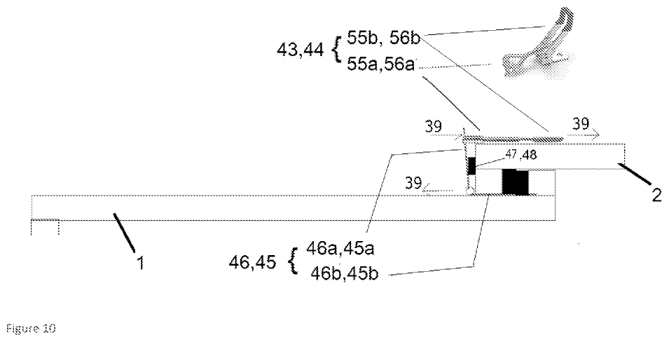

The hinges each comprise at least two hinge parts (FIG. 10, parts 45a,b and 46a,b—in gray). In the operating state (FIG. 9), the hinge part at the front in the direction of the longitudinal axis of the loudspeaker enclosure is folded out. In the operating state (FIG. 10), the front hinge part (46a, 45a) is pressed against an end face of the further enclosure section (47, 48), which has the higher cross section. With the transfer of the lever lock into a cocked position, a lever lock part of the lever lock engages over the hinge part arranged at the front of the hinge. As a result the force F(39) pushes the sealing elements (35, 37) against each other. With the transfer of the lever lock into the cocked position, the front hinge part of the hinge is braced against the further enclosure section. In this position, the first enclosure section and the further enclosure section are immovably braced against one another. In the tensioned position, the hinge fixes the first enclosure section in its position relative to the further enclosure section with the aid of the lever lock.

Optionally a profile protection (47, 48) may prevent the end face of the further enclosure section from being damaged by the pressure of the folded-up hinge part in its (further enclosure section) braced position against the first enclosure section. The profile protection can be made of metal or another material.

Optionally at least one stopper may be arranged, which fixes the hinge parts immovably in their position during the transport state. In this way it is prevented that the front hinge part unfolds unintentionally. The stopper can be a magnet or felt. The stopper can also be made of a different material.

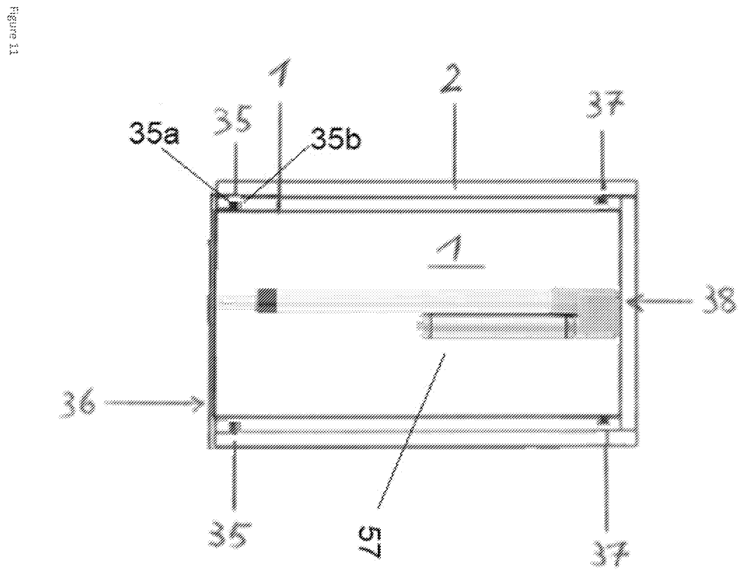

### Fourth Embodiment (FIG. 11, 12)

This embodiment shows how to fully automate (the automatism moves the enclosure sections from transportation mode to operation mode and vice versa) or partially automate (the automatism moves the enclosure sections only in the last part towards the operation mode) the switch from transport mode to operation mode (and eventually vice-versa).

The automatism is any device capable of pushing the enclosure sections apart from each other (in transportation mode—see FIG. 2) therefore compressing the sealing element (part 35), specially the soft stripe (part 35b) with a force F.

Just as example, the automatism device may be a linear or rotary actuator or a stepper motor. It may be electric or pneumatic/hydraulic.

There might be one or more devices to implement the automatism.

Note that the possible automation devices and their configuration and use in the context of moving two components away from each other applying the described force F are many and well known so they will not be described in detail. However, two examples (see next points) are provided.

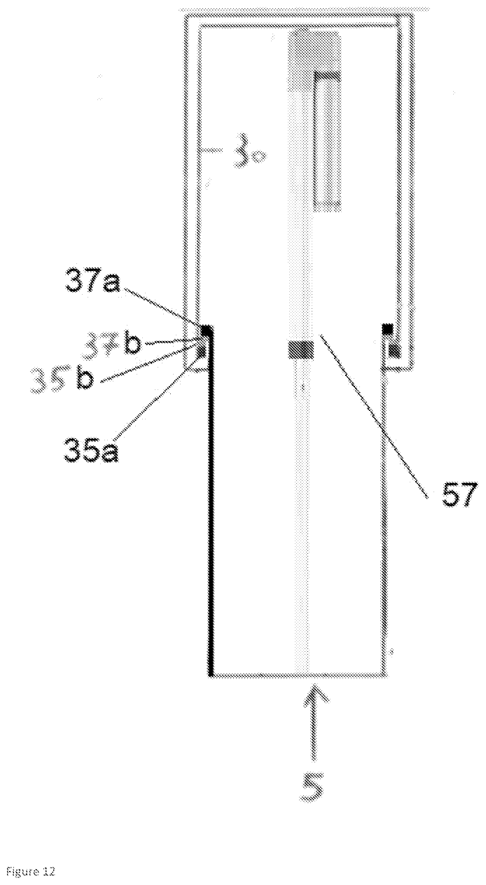

FIG. 11, 12 show an example of full automation using a linear actuator. FIG. 11 is in transport mode, FIG. 12 is in operation mode. The figures show one device (actuator) but there could be more.

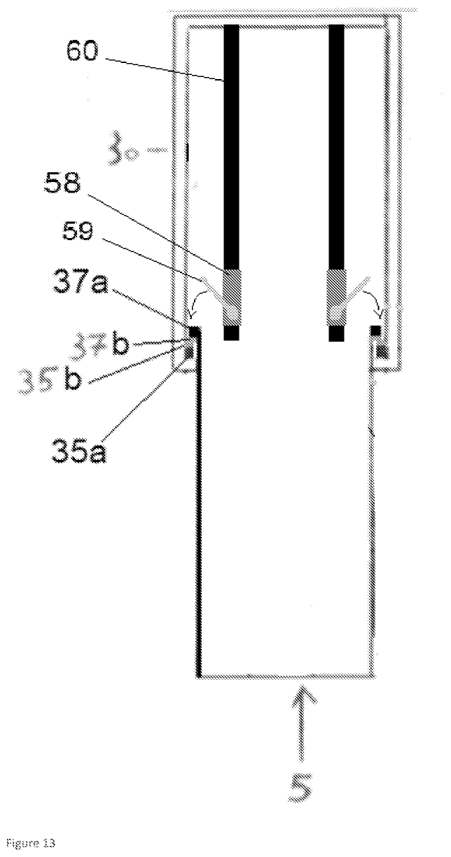

FIG. 13 shows an example of partial automation using a rotary actuator (part 58). The actuator is fixed to a bar (part 60) that is fixed to the external enclosure section. In order to switch from transport to operation mode the enclosure is first set to operation mode manually, then the actuator(s) are activated. Since the rod (part 59) is fixed to the rotating part of the actuator it will press against the internal enclosure section (at part 37a) with force F. The figure shows two devices (actuators) but there could be one or more.

For all embodiments:

The rod is preferably a narrow, long object. The rod can be a solid object. It can also be designed as a cylindrical, hollow body.

The rod can be a telescopic rod. The mutually movable sections of the telescopic rod are axially movable relative to each other.

The rod and/or the sections of the rod can be made of different materials as long as they can cope with the applied force. The rod and/or the sections of the rod can have different shapes and cross-sections.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A Loudspeaker enclosure comprising at least two enclosure sections (1, 2) which can be moved relative to one another into a transport state (3) and into an operating state (5), characterized in that the enclosure sections (1, 2) are connected to one another in the operating state (5) via a locking device and further characterized in that the enclosure sections (1, 2) each have one or more sealing elements (35, 37) which are pressed against one another by the locking device with a force F during the operating state (5).

2. A Loudspeaker enclosure according to claim 1 wherein the locking device comprises at least two components (8, 9, 11, 12, 43, 44, 45, 46), where the components are mutually pivotable in order to move the enclosure sections (1, 2) between the operating state (5) and the transport state (3).

3. A Loudspeaker enclosure according to claim 2, characterized in that the components (8, 9, 11, 12, 43, 44, 45, 46) are arranged at an angle to one another in the transport state (3) and axially aligned to one another in the operating state (5) (23, 24).

4. A Loudspeaker enclosure according to claim 2, characterized in that the components (8, 9, 11, 12) are mounted to one another in a rotatable way.

5. A Loudspeaker enclosure according to claim 4, characterized in that the components (8; 9, 11, 12) are connected to one another via a joint (19, 20).

6. A Loudspeaker enclosure according to claim 5, characterized in that the joint (19, 20) for the axial alignment (23, 24) of the sections (8, 9, 11, 12) of the locking device can be made immobilized in a positive or non-positive (or force-locking) manner.

7. A Loudspeaker enclosure according to claim 5, characterized in that the joint (19, 20) comprises blocking components (21, 22) with the aid of which the joint (19, 20) blocks itself.

8. A Loudspeaker enclosure according to claim 2, characterized in that the components (8, 9, 11, 12) form a rod (6, 10) which is designed as a telescopic rod.

9. A Loudspeaker enclosure according to claim 1, characterized in that the parts of the locking device which can be pivoted relative to one another are each designed as a hinge (45, 46) and a lever lock (43, 44), where the hinge (45, 46) and its related lever lock (43, 44) interact.

10. A Loudspeaker enclosure according to claim 9, characterized in that the hinge (45, 46) comprises hinge parts (45a, 45b, 46a, 46b) which can be pivoted in relation to one another.

11. A Loudspeaker enclosure according to claim 10, characterized in that the lever lock (43, 44) comprises lever lock parts (55a, 55b, 56a, 56b) which can be pivoted in relation to one another.

12. A Loudspeaker enclosure according to claim 1 comprising at least one automation device that fully or partially moves the enclosure sections from the transport state to the operating state and eventually vice versa.

13. A Loudspeaker enclosure according to claim 3, characterized in that the components (8, 9, 11, 12) are mounted to one another in a rotatable way.

14. A Loudspeaker enclosure according to claim 3, characterized in that the components (8, 9, 11, 12) form a rod (6, 10) which is designed as a telescopic rod.
